(19) United States
(12) Patent Application Publication
(10) Pub. No.: US 2018/0301852 A1
(43) Pub. Date: Oct. 18, 2018

(54) POWER-SAVING OUTLET

(71) Applicants: Maria Galkowski, Woodstock (CA); Jeremy Gambacort, Woodstock (CA)

(72) Inventors: Maria Galkowski, Woodstock (CA); Jeremy Gambacort, Woodstock (CA)

(21) Appl. No.: 15/956,673

(22) Filed: Apr. 18, 2018

Related U.S. Application Data
(60) Provisional application No. 62/486,962, filed on Apr. 18, 2017.

(51) Int. Cl. H01R 13/66; H01R 31/06; H01R 13/70; H01H 9/16

(52) U.S. Cl. CPC H01R 13/665; H01H 9/161; H01R 13/70; H01R 31/065

(57) ABSTRACT

A power-saving outlet is disclosed herein. The power-saving outlet includes a housing, a at least one outlet-socket, an electrical-circuit, at least one toggle-switch, and a state-indication means. In a preferred embodiment, the state-indication means is an LED light. The power-saving outlet may be useful for providing a means to prevent excess power consumption.

### CROSS REFERENCE TO RELATED APPLICATION

The present application is related to and claims priority to U.S. Provisional Patent Application No. 62/486,962 filed Apr. 18, 2017, which is incorporated by reference herein in its entirety.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### 1. Field of the Invention

The present invention relates generally to the field of power outlets and more specifically relates to switchable power outlets.

### 2. Description of Related Art

Since electricity is invisible, many people have no idea how much power is being consumed by an individual load. As such, it is very difficult to determine what devices to turn off or not use in an effort to conserve electricity. Even if one can read the power consumption label on the device, it can be difficult for the average consumer to determine what it costs per minute or per hour to run such equipment.

Most people leave various household appliances and devices plugged in, even when turned off, including televisions, washers and dryers, laptops and computers, chargers, coffee makers, and more. Unfortunately, even though these electronics are not turned on, they still draw electricity, which is not only wasteful but can become expensive, as they can cumulatively drive up a household's utility bill. Some people may try to unplug every appliance or device, but this is not convenient or practical. A suitable solution is desired.

U.S. Pub. No. 2010/0038218 to Fisher et al. relates to a switchable electrical power outlet adapter and associated methods. The described switchable electrical power outlet adapter and associated methods includes a switchable electrical power outlet adapter and a switchable electrical power outlet. Each includes a receptacle socket configured for receipt of a plug of an electric appliance; a control circuit disposed within the housing, the control circuit configured to selectively terminate electrical connectivity between the electrical receptacle and the electrical appliance; and a switch disposed upon the housing and electrically connected to the control circuit, the switch having an ON state and an OFF state. The OFF state of the switch is visually represented on the housing of the switchable electrical power outlet adapter as GREEN to encourage greater use of the switchable electrical power outlet adapter and greater energy efficiency.

### BRIEF SUMMARY OF THE INVENTION

In view of the foregoing disadvantages inherent in the known power outlets art, the present disclosure provides a novel power-saving outlet. The general purpose of the present disclosure, which will be described subsequently in greater detail, is to provide an outlet including a power switch, and power-state indication means for saving excess power consumption.

A power-saving outlet is disclosed herein. The power-saving outlet includes a housing including a front-side and a back-side relative to a wall of a building when installed; at least one outlet-socket located on the front-side of the housing and configured to receive a plug of the electrical appliance; and an electrical-circuit disposed within the housing configured to provide power to an electrical appliance when a plug of the electrical appliance may be plugged into the at least one outlet-socket. The power-saving outlet further includes at least one toggle-switch and a state-indication means. The at least one toggle-switch is located on the front-side of the housing, the at least one toggle-switch includes an on-state and an off-state, the at least one toggle-switch being electrically connected to the electrical-circuit, and the at least one toggle-switch being configured to selectively break a continuity of the electrical-circuit via the off-state, and selectively rejoin the continuity of the electrical circuit via the on-state. The state-indication means is located on the front-side of the housing, the state-indication means being electrically connected to the at least one toggle-switch, the state-indication means is configured to indicate which of the on-state and the off-state the at least one toggle-switch is in.

A method of using power-saving outlet is also disclosed herein. The method of using power-saving outlet may comprise the steps of: providing the power-saving outlet as above; plugging the plug of the electrical appliance into the at least one outlet-socket; pressing one of a first side and a second side of the toggle-switch to turn the toggle-switch to the on-state; and using the electrical appliance.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a power-saving outlet, constructed and operative according to the teachings of the present disclosure.

FIG. 1 is a front view of the power-saving outlet during an ‘in-use’ condition, according to an embodiment of the disclosure.

FIG. 2 is a detail view of the power-saving outlet of FIG. 1 showing the power-saving outlet from its perspective, back, and side, according to an embodiment of the present disclosure.

FIG. 3 is a schematic diagram of the circuitry of the power-saving outlet of FIG. 1, according to an embodiment of the present disclosure.

FIG. 4 is a front view of the power-saving outlet of FIG. 1, according to an embodiment of the present disclosure.

FIG. 5 is a flow diagram illustrating a method of use for power-saving outlet, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to power outlets and more particularly to a power-saving outlet as used to improve power-saving outlets including a power switch.

Generally, disclosed is a power-saving receptacle which may cut power to a plugged-in appliance or device when not in use. The power-saving receptacle may comprise an outlet receptacle that includes a toggle switch, positioned horizontally on the receptacle, with a light indication means to signify the presence of power and to allow users to quickly determine whether the receptacle is on or off. The toggle switch may allow the users to turn power to the receptacle on or off, preventing the receptacle from wasting power to plugged in, yet unused, appliances and devices. Further, the power-saving receptacle may alleviate the hassle of constantly plugging in and unplugging appliances and devices. Additionally, the receptacle may be offered in various colors to accommodate the aesthetic of any room or decor.

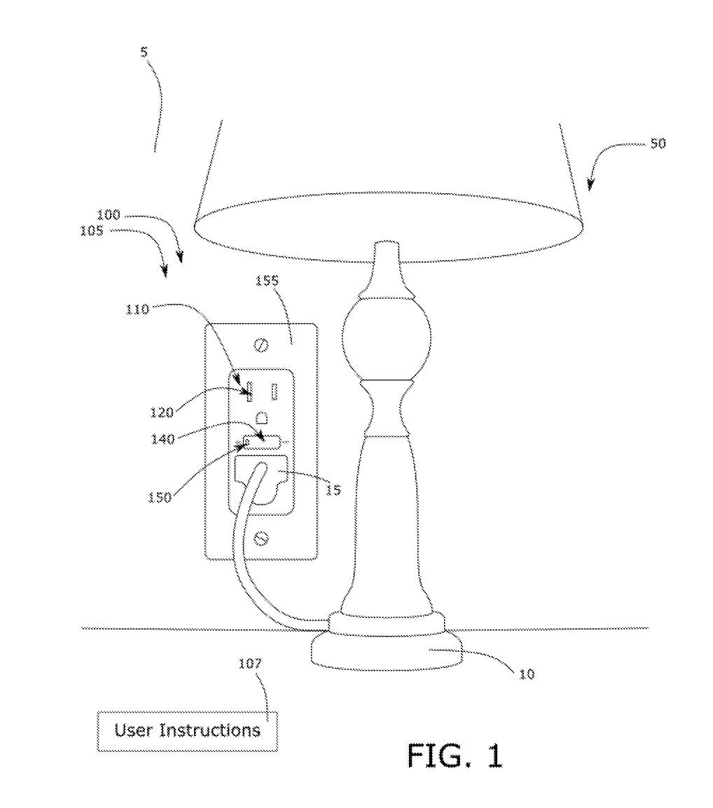

Referring now more specifically to the drawings by numerals of reference, there is shown in FIGS. 1-4, various views of a power-saving outlet 100.

FIG. 1 shows a power-saving outlet 100 during an ‘in-use’ condition 50, according to an embodiment of the present disclosure. Shown here is the power-saving outlet 100 installed on a wall 5 of a building, and electrically connected to a power supply of the building. The power supply of the building may be configured to provide power to an electrical appliance 10 via the power-saving outlet 100. For example, the power supply of the building may provide household AC power. Here, the electrical appliance 10 is shown to be a lamp.

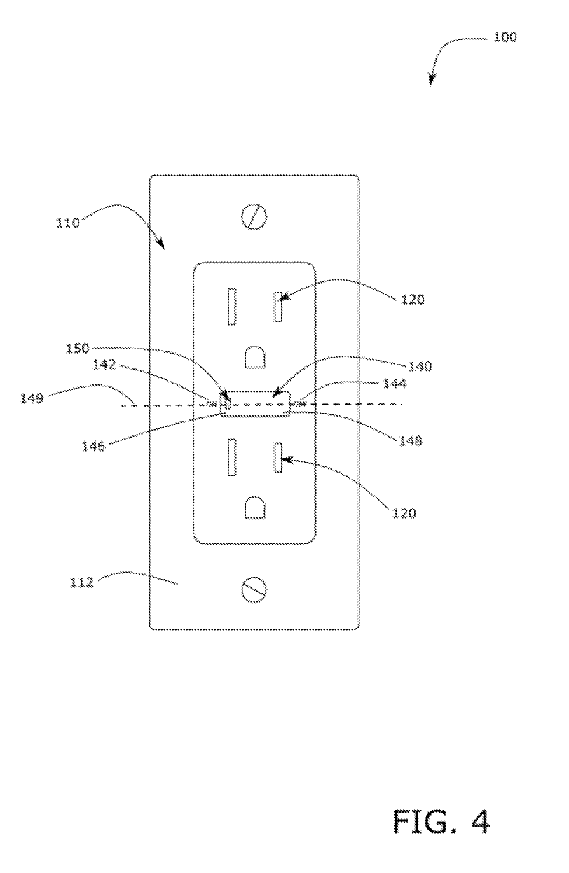

As illustrated, the power-saving outlet 100 may include a housing 110, at least one outlet-socket 120, an electrical-circuit 130 (FIG. 4), at least one toggle-switch 140, a state-indication means 150. Further, the power-saving outlet 100 may include a hot wire, a neutral wire and a ground wire for electrical connection to the power supply of the building.

According to one embodiment, the power-saving outlet 100 may be arranged as a kit 105. The kit 105 may include a set of instructions 107. The instructions 107 may detail functional relationships in relation to the structure of the power-saving outlet 100 (such that the power-saving outlet 100 can be used, maintained, or the like, in a preferred manner).

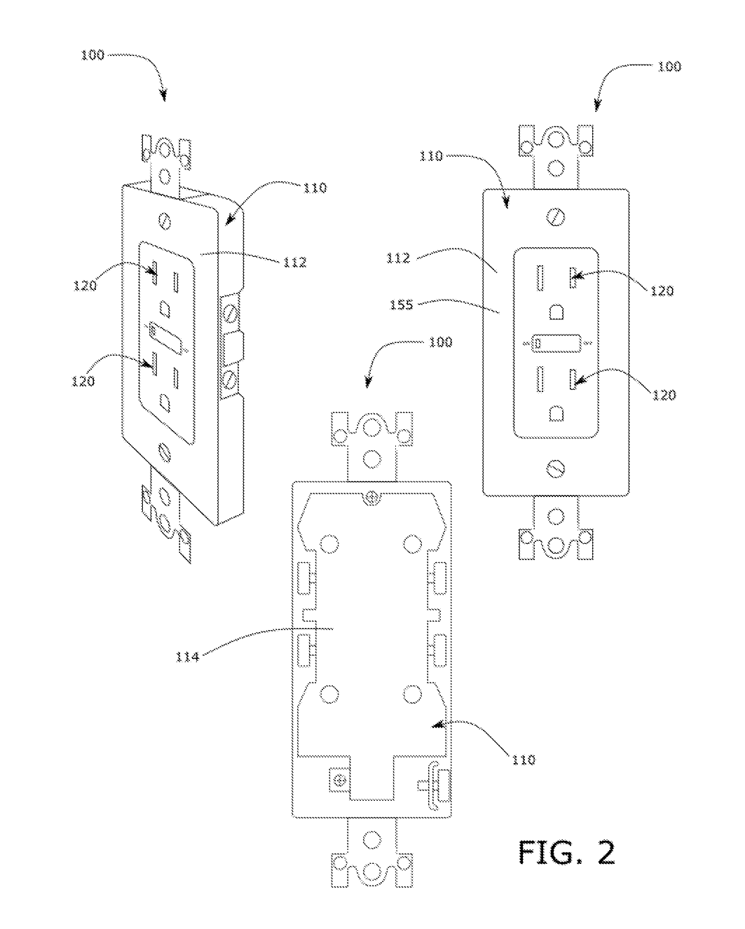

FIG. 2 is a detail view of the power-saving outlet of FIG. 1 showing the power-saving outlet from its perspective, back, and side, according to an embodiment of the present disclosure. Shown here the power-saving outlet 100 in isolation and uninstalled from the wall 5 (FIG. 1) of the building. As shown, the housing 110 may include a front-side 112 and a back-side 114 relative the wall 5 when installed.

In one embodiment, the power-saving outlet 100 may further include a decorative face 155 (FIG. 1) affixed to and circumscribing the housing 110. The decorative face 155 may include a variety of colors, designs, shapes, etc. In some examples, the decorative face 155 may include brand logos or brand designs. In a preferred embodiment, the front-side 112 of the housing 110 may be made from a plastic material. However, other materials may be used.

Further, the at least one outlet-socket 120 may be located on the front-side 112 of the housing 110 and may be configured to receive a plug 15 (FIG. 1) of the electrical appliance 10 (FIG. 1). As shown in this figure, the at least one outlet-socket 120 may include two outlet-sockets.

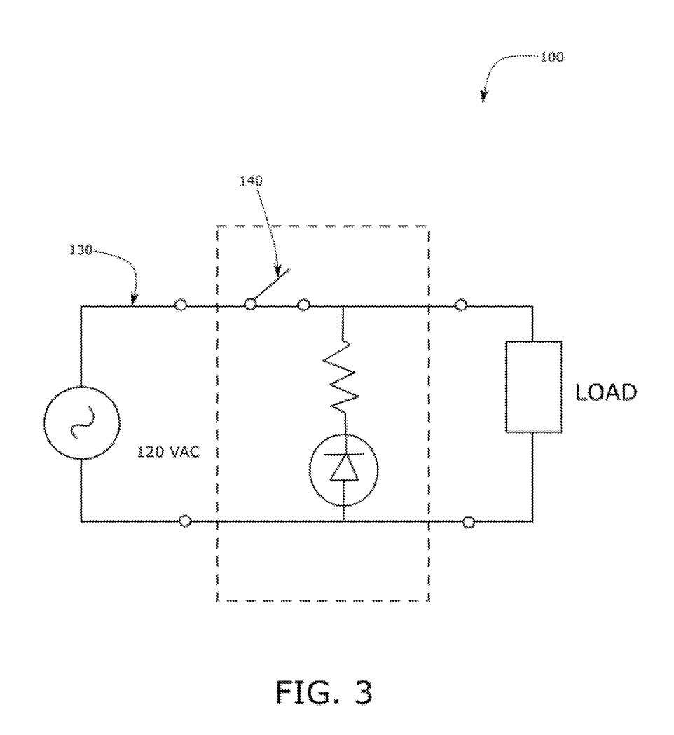

FIG. 3 is a schematic diagram of the circuitry of the power-saving outlet of FIG. 1, according to an embodiment of the present disclosure. The electrical-circuit 130 may be disposed within the housing 110 (FIG. 1) and may be configured to provide the power to the electrical appliance 10 (FIG. 1) when the plug 15 (FIG. 1) is plugged into the at least one outlet-socket 120 (FIG. 1).

Also illustrated is the at least one toggle-switch 140. In the preferred embodiment, the at least one toggle-switch 140 may include an on-state and an off-state. Further, the at least one toggle-switch 140 may be electrically connected to the electrical-circuit 130 and configured to selectively interrupt continuity of the electrical-circuit 130 when placed in the off-state, and close continuity of the electrical circuit when placed in the on-state. Shown in this figure is the at least one toggle switch in the off-state, with the continuity of the electric-circuit 130 being broken.

FIG. 4 is a front view of the power-saving outlet 100 of FIG. 1, according to an embodiment of the present disclosure. Shown here is the at least one toggle-switch 140 and the state-indication means 150. As shown, the at least one toggle-switch 140 may be located on the front-side 112 of the housing 110.

In a preferred embodiment, the at least one toggle-switch 140 may be a toggle button or switch operable by pressing a first side 146 or a second side 148, opposite the first side 146. In this embodiment, the at least one outlet-socket 120 may include two outlet sockets separated by the toggle button, and opposite a dividing line 149. The toggle-switch 140 may include the first side 146 and the second side 148 opposite the first side 146 along the dividing line 149. The toggle-switch 140 may then be selectable between the on-state and the off-state by pressing the first side 146 and the second side 148, respectively.

As shown, the state-indication means 150 may be located on the front-side 112 of the housing 110. In this embodiment, the state-indication means 150 may be electrically connected to the at least one toggle-switch 140 and configured to indicate which of the on-state and the off-state the at least one toggle-switch 140 is in. In a preferred embodiment, the state-indication means 150 may be a light configured to illuminate when the at least one toggle-switch 140 is in the on-state. In this preferred embodiment, the light may be a light emitting diode (LED). In this embodiment, when the at least one toggle switch is in the on-state, the power may be supplied to the state-indication means 150 such that the light emitting diode can illuminate. In other embodiments, the state-indication means 150 may be configured to illuminate when the at least one toggle-switch 140 is in the off-state.

As illustrated, the state-indication means 150 may be located on the at least one toggle-switch 140. Further, as illustrated, the front-side 112 of the housing 110 may further include a state-indication indicia. In this embodiment, the state-indication indicia may include an “OFF” indicia 144. The “OFF” indicia 144 may be located adjacent one of the first-side 146 and the second-side 148 and may be indicative of the off-state. Similarly, the state-indication indicia 152 may further include an “ON” indicia 142 and the “ON” indicia 142 may be located adjacent another one of the first-side 146 and the second-side 148, and may be indicative of the on-state. For example, the “OFF” indicia 144 may be located on the first-side 146 of the at least one toggle-switch 140, and the user may press the first-side 146 to select the off-state of the at least one toggle-switch 140.

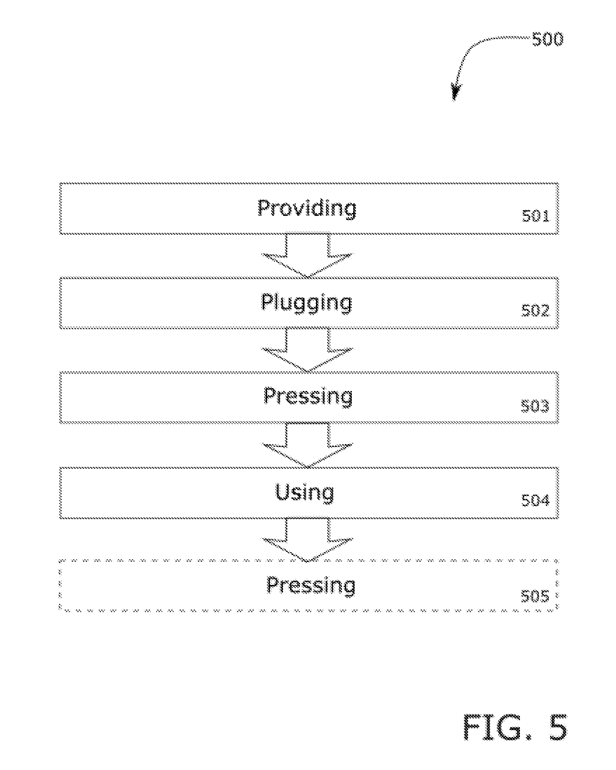

FIG. 5 is a flow diagram illustrating a method 500 for using a power-saving outlet, according to an embodiment of the present disclosure. As illustrated, the method for using a power-saving outlet 500 may include the steps of: step one 501, providing the power-saving outlet 100 as above; step two 502, plugging the plug 15 of the electrical appliance 10 into the at least one outlet-socket 120; step three 503, pressing one of a first side 146 and a second side 148 of the toggle-switch to turn the toggle-switch to the on-state; and step four 504, using the electrical appliance 10. According to one embodiment, the method 500 may further include a step five 505, pressing on another of the first side 146 and the second side 148 of the at least one toggle-switch 140 to turn the toggle-switch 140 to the off-state.

It should be noted that step five 505 is an optional step and may not be implemented in all cases. Optional steps of method 500 are illustrated using dotted lines in FIG. 5 so as to distinguish them from the other steps of method of use 500. It should also be noted that the steps described in the method of use can be carried out in many different orders according to user preference. The use of “step of” should not be interpreted as “step for”, in the claims herein and is not intended to invoke the provisions of 35 U.S.C. § 112(f). It should also be noted that, under appropriate circumstances, considering such issues as design preference, user preferences, marketing preferences, cost, structural requirements, available materials, technological advances, etc., other methods for power-saving outlet 100 (e.g., different step orders within above-mentioned list, elimination or addition of certain steps, including or excluding certain maintenance steps, etc.), are taught herein.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A power-saving outlet for installation onto a wall of a building, and for electrical connection to a power supply of the building, the power supply being configured to provide power to an electrical appliance via the power-saving outlet, the power-saving outlet comprising:
a housing including a front-side and a back-side relative the wall when installed;
at least one outlet-socket located on the front-side of the housing, the at least one outlet-socket being configured to receive a plug of the electrical appliance;
an electrical-circuit disposed within the housing, the electrical-circuit configured to provide the power to the electrical appliance when the plug is plugged into the at least one outlet-socket;
at least one toggle-switch located on the front-side of the housing, the at least one toggle-switch including an on-state and an off-state, the at least one toggle-switch being electrically connected to the electrical-circuit, and the at least one toggle-switch being configured to selectively break a continuity of the electrical-circuit via the off-state, and selectively rejoin the continuity of the electrical circuit via the on-state; and
a state-indication means located on the front-side of the housing, the state-indication means being electrically connected to the at least one toggle-switch, the state-indication means being configured to indicate which of the on-state and the off-state the at least one toggle-switch is in.

2. The power-saving outlet of claim 1, wherein the state-indication means is a light configured to illuminate when the at least one toggle-switch is in the on-state.

3. The power-saving outlet of claim 1, wherein the state-indication means is the light configured to illuminate when the at least one toggle-switch is in the off-state.

4. The power-saving outlet of claim 3, wherein the light is a light emitting diode.

5. The power-saving outlet of claim 4, wherein the state-indication means is located on the at least one toggle-switch.

6. The power-saving outlet of claim 1, wherein the at least one toggle-switch is a toggle button operable by pressing a first side or a second side, opposite the first side.

7. The power-saving outlet of claim 6, wherein the at least one outlet-socket includes two outlet sockets separated by the toggle button, and opposite a dividing line; and
wherein the toggle button includes a first side and a second side opposite the first side along the dividing line.

8. The power-saving outlet of claim 7, wherein the toggle button is selectable between the on-state and the off-state by pressing the first side and the second side, respectively.

9. The power-saving outlet of claim 1, wherein the front-side of the housing further includes a state-indication indicia.

10. The power-saving outlet of claim 9, wherein the state-indication indicia includes an “OFF” indicia.

11. The power-saving outlet of claim 9, wherein the “OFF” indicia is located adjacent one of the first-side and the second-side, and is indicative of the off-state.

12. The power-saving outlet of claim 9, wherein the state-indication indicia further includes an “ON” indicia.

13. The power-saving outlet of claim 9, wherein the “ON” indicia is located adjacent another one of the first-side and the second-side, and is indicative of the on-state.

14. The power-saving outlet of claim 1, further comprising a decorative face affixed to and circumscribing the housing.

15. The power-saving outlet of claim 1, wherein the at least one outlet-socket includes two outlet-sockets.

16. The power-saving outlet of claim 1, wherein the front-side of the housing is made from a plastic material.

17. A power-saving outlet for installation onto a wall of a building, and for electrical connection to a power supply of the building, the power supply being configured to provide power to an electrical appliance via the power-saving outlet, the power-saving outlet comprising:
a housing including a front-side and a back-side relative the wall when installed;
at least one outlet-socket located on the front-side of the housing, the at least one outlet-socket being configured to receive a plug of the electrical appliance;
an electrical-circuit disposed within the housing, the electrical-circuit configured to provide the power to the electrical appliance when the plug is plugged into the at least one outlet-socket;
at least one toggle-switch located on the front-side of the housing, the at least one toggle-switch including an on-state and an off-state, the at least one toggle-switch being electrically connected to the electrical-circuit, and the at least one toggle-switch being configured to selectively break a continuity of the electrical-circuit via the off-state, and selectively rejoin the continuity of the electrical circuit via the on-state; and
a state-indication means located on the front-side of the housing, the state-indication means being electrically connected to the at least one toggle-switch, the state-indication means being configured to indicate which of the on-state and the off-state the at least one toggle-switch is in; and
wherein the state-indication means is a light configured to illuminate when the at least one toggle-switch is in the on-state;
wherein the state-indication means is the light configured to illuminate when the at least one toggle-switch is in the off-state;
wherein the light is a light emitting diode;
wherein the state-indication means is located on the at least one toggle-switch;
wherein the at least one toggle-switch is a toggle button operable by pressing a first side or a second side, opposite the first side;
wherein the at least one outlet-socket includes two outlet sockets separated by the toggle button, and opposite a dividing line;
wherein the toggle button includes a first side and a second side opposite the first side along the dividing line;
wherein the toggle button is selectable between the on-state and the off-state by pressing the first side and the second side, respectively;
wherein the front-side of the housing further includes a state-indication indicia;
wherein the state-indication indicia includes an “OFF” indicia;
wherein the “OFF” indicia is located adjacent one of the first-side and the second-side, and is indicative of the off-state;
wherein the state-indication indicia further includes an “ON” indicia;
wherein the “ON” indicia is located adjacent another one of the first-side and the second-side, and is indicative of the on-state;
wherein the power-saving outlet further comprises a decorative face affixed to and circumscribing the housing;
wherein the at least one outlet-socket includes two outlet-sockets; and
wherein the front-side of the housing is made from a plastic material.

18. The power-saving outlet of claim 17, further comprising set of instructions; and
wherein the power-saving outlet is arranged as a kit.

19. A method for using a power-saving outlet, the power-saving outlet being installed onto a wall of a building, and electrically connected to a power supply of the building, the power supply being configured to provide power to an electrical appliance via the power-saving outlet, the method comprising the steps of:
providing the power-saving outlet including:
a housing including a front-side and a back-side relative the wall when installed;
at least one outlet-socket located on the front-side of the housing, the at least one outlet-socket being configured to receive a plug of the electrical appliance;
an electrical-circuit disposed within the housing, the electrical-circuit configured to provide the power to the electrical appliance when the plug is plugged into the at least one outlet-socket;
at least one toggle-switch located on the front-side of the housing, the at least one toggle-switch including an on-state and an off-state, the at least one toggle-switch being electrically connected to the electrical-circuit, and the at least one toggle-switch being configured to selectively break a continuity of the electrical-circuit via the off-state, and selectively rejoin the continuity of the electrical circuit via the on-state; and
a state-indication means located on the front-side of the housing, the state-indication means being electrically connected to the at least one toggle-switch, the state-indication means being configured to indicate which of the on-state and the off-state the at least one toggle-switch is in;
plugging the plug of the electrical appliance into the at least one outlet-socket;
pressing one of a first side and a second side of the toggle-switch to turn the toggle-switch to the on-state; and
using the electrical appliance.

20. The method of claim 19, further comprising the step of pressing on another of the first side and the second side of the toggle-switch to turn the toggle-switch to the off-state
